(19) United States
(12) Patent Application Publication
(10) Pub. No.: US 2013/0135769 A1
(43) Pub. Date: May 30, 2013

(54) MAGNETIC HEAD INSPECTION APPARATUS AND MAGNETIC HEAD INSPECTION METHOD

(71) Applicant: Hitachi High-Technologies Corporation, Tokyo (JP)

(72) Inventors: Kunihito HIGA, Kamisato-machi (JP); Yoshihiro SAKURAI, Kamisato-machi (JP); Yukio YAMAMOTO, Hitachi-shi (JP)

(73) Assignee: Hitachi High-Technologies Corporation, Tokyo (JP)

(21) Appl. No.: 13/680,249

(22) Filed: Nov. 19, 2012

(30) Foreign Application Priority Data
Nov. 25, 2011 (JP) 2011-257630

(51) Int. Cl. G11B 21/10

(52) U.S. Cl. CPC G11B 21/106
USPC 360/78.05

(57) ABSTRACT

In inspection for a magnetic head having a built-in fine-motion actuator, stable servo control is realized without an effect of thermal drift or thermal expansion. A magnetic head inspection apparatus includes a fine-motion stage, a data process circuit, and a servo control circuit. The fine-motion stage performs positioning of a magnetic head in a predetermined position on a magnetic disk. The data process circuit measures the movement characteristic of the fine-motion actuator. The servo control circuit controls the magnetic head to track the servo track on the magnetic disk based on a measurement result of the data process circuit. The servo control circuit drives the fine-motion stage, and controls the magnetic head to move in a manner that the value of movement of the fine-motion actuator remains within an acceptable range.

### CLAIM OF PRIORITY

The present application claims priority from Japanese patent application serial No. JP 2011-257630, filed on Nov. 25, 2011, the content of which is hereby incorporated by reference into this application.

### BACKGROUND OF THE INVENTION

(1) Field of the Invention

The present invention relates to a magnetic head inspection apparatus and a magnetic head inspection method, and, more particularly, to a servo tracking technique for a magnetic head having a built-in fine-motion actuator.

(2) Description of the Related Art

In a magnetic head inspection method, to write and read data for inspection, an inspection magnetic head is controlled to track a predetermined track, in accordance with a servo signal written onto a magnetic disk, thereby inspecting the performance of the magnetic head. To attempt an increase in recording density, the magnetic head is required to perform high accuracy positioning for the track. Thus, dual control is applied to the positioning of the magnetic head. In the dual control, coarse-motion control and fine-motion control are performed in combination with each other.

Japanese Patent Application Laid-Open Publication No. 2009-080923 discloses a technique for writing servo information, with an object for improving the throughput of the inspection process. Specifically, in this technique, there is no need to write servo information on the magnetic disk, every time a magnetic head assembly is changed, when continuously recording the servo information using both a coarse-motion stage and a fine-motion stage.

Japanese Patent Application Laid-Open Publication No. 2009-016030 discloses a movement performance testing method for a micro actuator using a low driving voltage, in a magnetic head in which a micro actuator for correcting the position of a magnetic head slider is mounted on the suspension.

### SUMMARY OF THE INVENTION

In dual servo control technique in a magnetic head inspection apparatus, when tracking the magnetic head in accordance with a servo signal written on a magnetic disk, a coarse-motion actuator movable in a wide region corresponding to servo track spaces is applied in the first stage, and precise positioning for the track can be performed using a fine-motion actuator built in the magnetic head as disclosed in Japanese Patent Application Laid-Open Publication No. 2009-016030. The magnetic head with a built-in fine-motion actuator is called also a DSA (Dual Stage Actuator) head. The weight of a target to be controlled by the actuator is light, thus enabling high-speed control. Because the movable region becomes small, the DSA head also has a problem is that servo tracking can not be performed if the value of the movement exceeds a predetermined value due to a noise factor, such as thermal drift and the like.

In the movement performance testing method of Japanese Patent Application Laid-Open Publication No. 2009-016030, initial track data is written on the magnetic disk using the DSA head, and the track data is written in a state where a predetermined voltage is applied to the micro actuator of the DSA head. Finally, the track data is read, thereby obtaining the value of movement of the micro actuator. According to this method, the track position may undesirably and relatively shift (drift) due to heat from a write current when writing the track data or thermal expansion of the magnetic disk during the inspection time. This causes a difficulty in high accuracy test. The inspection for the micro actuator and the READ/WRITE inspection are separately performed. As a result, the DSA head cannot totally be inspected as a whole.

An object of the present invention is to provide a magnetic head inspection apparatus and a magnetic head inspection method for realizing stable servo control, without an effect of thermal drift and thermal expansion, in inspection for a magnetic head having a built-in fine-motion actuator.

According to the present invention, there is provided a magnetic head inspection apparatus which inspects a characteristic of a magnetic head having a built-in fine-motion actuator, comprising: a fine-motion stage which performs positioning of the magnetic head in a predetermined position on a magnetic disk; a data process circuit which measures a movement characteristic of the fine-motion actuator; and a servo control circuit which controls the magnetic head to track a servo track on the magnetic disk, based on a measurement result of the data process circuit, and wherein when a value of movement of the fine-motion actuator exceeds an acceptable range in accordance with the measurement result, the servo control circuit drives the fine-motion stage and controls the magnetic head to move in a manner that the value of movement of the fine-motion actuator remains within the acceptable range.

According to the present invention, there is provided a magnetic head inspection method for inspecting a characteristic of a magnetic head having a built-in fine-motion actuator, the method comprising the steps of: measuring a movement characteristic of the fine-motion actuator built in the magnetic head, to obtain an acceptable range of a value of movement; moving the fine-motion actuator, to control the magnetic head to track a servo track on the magnetic head; and when the value of movement of the fine-motion actuator exceeds the acceptable range, controlling a fine-motion stage having the magnetic head mounted thereon to move, to control the value of movement of the fine-motion actuator to remain within the acceptable range.

According to the present invention, it is possible to realize stable servo control without an effect of thermal drift and thermal expansion, in inspection for a magnetic head having a built-in fine-motion actuator.

### BRIEF DESCRIPTION OF THE DRAWINGS

FIG. 1 is a block diagram showing an embodiment of a magnetic head inspection apparatus according to the present invention.

FIG. 2 is a diagram showing the servo pattern on a magnetic disk and the trace of a magnetic head.

FIG. 3 is a diagram showing the movement characteristics (DSA characteristics) of the magnetic head.

FIG. 4 is a diagram for explaining the operation of dual servo control, according to the embodiment.

### DETAILED DESCRIPTION OF THE EMBODIMENT

An embodiment of the present invention will now be described with reference to the accompanying drawings.

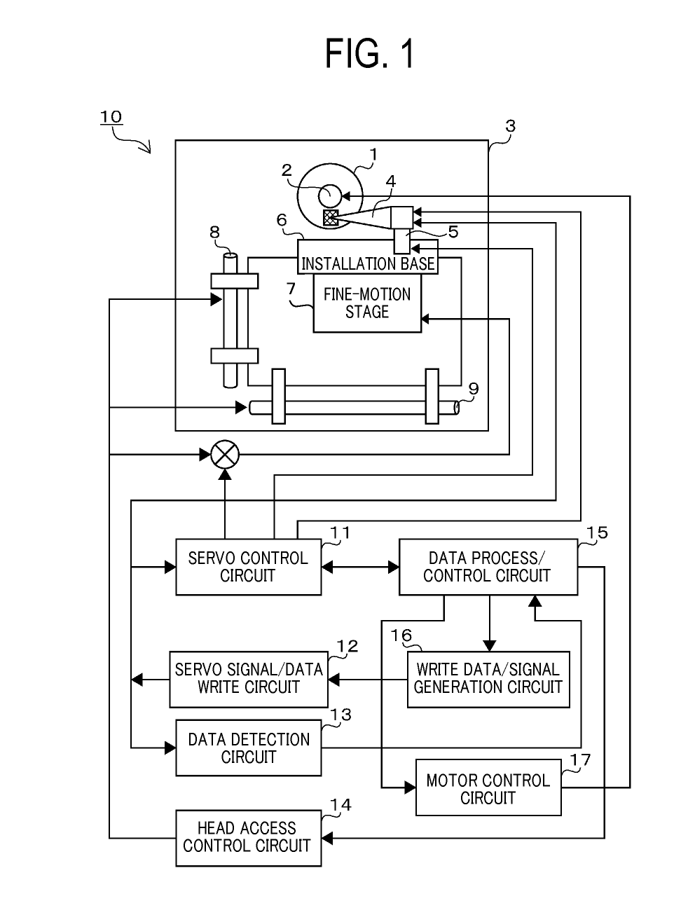

FIG. 1 is a block diagram showing an embodiment of a magnetic head inspection apparatus according to the present invention. In this embodiment, a target object to be inspected is a DSA magnetic head (hereinafter referred to as a magnetic head) having a built-in a fine-motion actuator, such as a piezo-electric device.

A magnetic head inspection apparatus 10 includes an inspection carriage 3 including a mechanical section which performs a mechanical operation, and includes also electric circuits 11 to 17 connected to the carriage 3. The inspection carriage 3 has a spindle motor 2 which revolves the magnetic disk 1 and mechanisms 5 to 9 for positioning the magnetic head 4 on the magnetic disk 1. An X-axis coarse-motion stage 8 and a Y-axis coarse-motion stage 9 are provided to move the magnetic head 4 externally from the magnetic disk 1 onto the magnetic disk 1. The X-axis coarse-motion stage 8 moves the magnetic head 4 in a radial direction of the magnetic disk 1, while the Y-axis coarse-motion stage 9 moves the magnetic head 4 into the circumferential direction of the magnetic disk 1. A fine-motion stage 7 which can perform micro positioning is mounted on the X-axis coarse-motion stage 8 and the Y-axis coarse-motion stage 9. A head cartridge 5 on which the target magnetic head 4 for inspection is mounted is provided on the fine-motion stage 7, through a cartridge installation base 6. This magnetic head 4 includes a fine-motion actuator having a non-illustrative built-in magnetic head therein. The fine-motion stage 7 is driven to position the magnetic head 4 in a desired track position on the magnetic disk 1, to measure read/write characteristics of the magnetic head 4 (also called “parametric characteristic”). For positioning of the magnetic head 4, the head cartridge 5 may be equipped with the fine-motion actuator in place of the fine-motion stage 7.

Descriptions will now be made to configurations of the electric circuits 11 to 17. The data process/control circuit 15 issues parameters necessary for operation conditions for the circuits. The motor control circuit 17 controls revolving of the spindle motor 2 at an appropriate speed, in accordance with an instruction from the data process/control circuit 15. The head access control circuit 14 activates the X-axis coarse-motion stage 8, the Y-axis coarse-motion stage 9, and the fine-motion stage 7, and loads the magnetic head 4 onto the magnetic disk 1.

The write data/signal generation circuit 16 and the servo signal/data write circuit 12 write parametric measurement data and a servo signal onto the magnetic disk 1 using the magnetic head 4. The servo signal is necessary information for the magnetic disk 4 to perform servo tracking onto the magnetic disk 1, and is formed in the form of a servo pattern 100, in accordance with information generate by the data process/control circuit 15.

The servo control circuit 11 processes information of the servo pattern 100 on the magnetic disk 1, read by the magnetic head 4, and sends a control signal to the fine-motion stage 7 (or the head cartridge 5) and the magnetic head 4, thereby performing servo tracking. This control signal includes a driving signal for the fine-motion actuator of the magnetic head 4. An instruction for performing servo tracking is issued from the data process/control circuit 15. The data detection circuit 13 detects data on the magnetic disk 1. This data is read by the magnetic head 4. Then, the detected data is sent to the data process/control circuit 15 and processed as measurement data of the magnetic head 4.

Descriptions will now be made to the operation of the magnetic head inspection apparatus according to this embodiment.

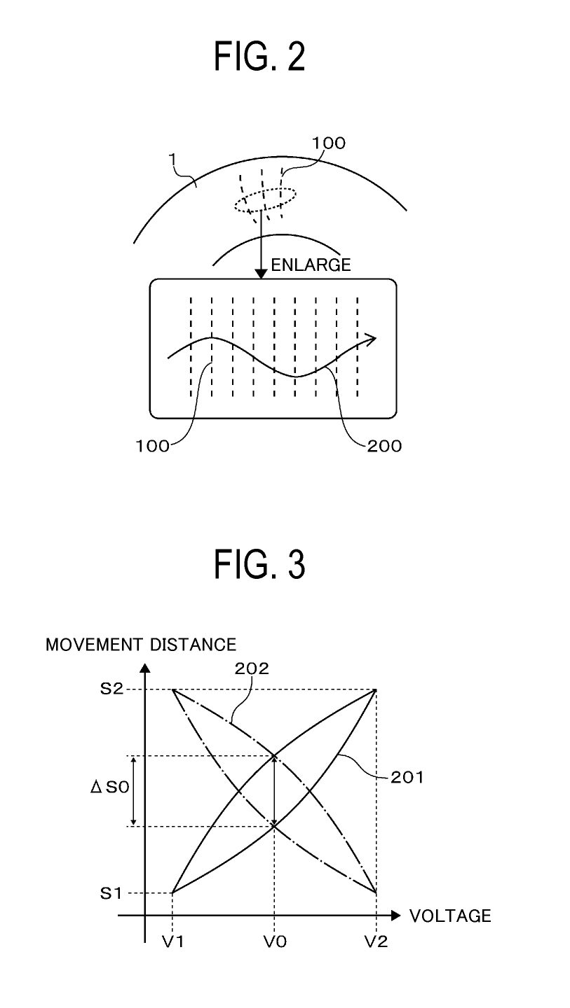

FIG. 2 is a diagram showing the servo pattern on the magnetic disk and the trace of the magnetic head.

The head access control circuit 14 operates the X-axis coarse-motion stage 8, the Y-axis coarse-motion stage 9, and the fine-motion stage 7, to load the magnetic head 4 into an arbitrary position of the magnetic disk 1. The servo control circuit 11 drives the fine-motion stage 7 (or the head cartridge 5), to perform the tracking operation for the servo pattern 100 on the magnetic disk 4. At this time, because no control voltage is applied to the fine-motion actuator of the magnetic head 4, the position of the magnetic head 4 is fixed, that is, functions of the magnetic head 4 are stopped (alternatively, a constant voltage may be given to the fine-motion actuator). This servo pattern 100 may be a pattern which is written in advance by another magnetic head or a pattern which is written by the target magnetic head 4 to be inspected, as long as the position information on the magnetic disk 1 can be judged.

If the servo tracking is confirmed, the movement characteristics (hereinafter referred to as DSA characteristics) of the magnetic head 4 are measured. To measure the DSA characteristics, the servo tracking is stopped once, a constant amplitude sine wave signal (SIN wave) is applied to the fine-motion actuator of the magnetic head 4. The frequency Fm of this SIN wave signal is determined based on Equation (1) to Equation (4).

Fm=Fs·N sin/Np (1)

Fs=Nsect·Nd (2)

N sin=2m−1 (3)

Np=4n (4)

In this case, Fs: sampling frequency, Nsin: SIN wave number, Np: number of measurement points, Nsect: number of sectors, Nd: number of disk revolutions, m: arbitrary positive integer, and n: arbitrary positive integer.

As described above, by setting the frequency Fm of the SIN wave, the maximum and minimum values of the SIN wave can be sampled, in positions of the servo pattern 100 in synchronism with the revolutions of the magnetic disk 1. By applying a SIN wave signal with the above condition to the magnetic head 4, the magnetic head 4 changes its position into a radial direction on the magnetic disk 1 to draw a head trace 200 within the range of the servo pattern 100. The movement distance in the radial direction of the magnetic head 4 can be read from the servo pattern 100, and the movement characteristics (DSA characteristics) of the magnetic head 4 can be obtained.

FIG. 3 is a diagram showing the movement characteristics (DSA characteristics) of the magnetic head, and shows the relationship between the applied voltage and the movement distance. In this case, the applied voltage is changed in a range from V1 to V2 at the center of V0, and the change (from S1 to S2) in the movement distance is measured. The DSA characteristics are of two types, a proportional type 201 in which the applied voltage and the movement distance are in proportion to each other, and an inverse proportional type 202 with an inverse proportional relationship therebetween.

The DSA characteristics have hysteresis ΔS0 at voltage V0, due to the hysteresis characteristics of the fine-motion actuator. The slope (DSA sensitivity) of the DSA characteristics can be obtained from Equation (5), as the ratio of the movement distance (S2−S1) to the applied voltage (V2−V1)

DSA sensitivity=(S2−S1)/(V2−V1) (5)

The DSA sensitivity is given with a positive/negative sign, in accordance with the proportional/inverse-proportional type of the DSA characteristics.

The servo tracking operation (dual servo control) of the magnetic head for inspection 4, based on the above-described DSA characteristics.

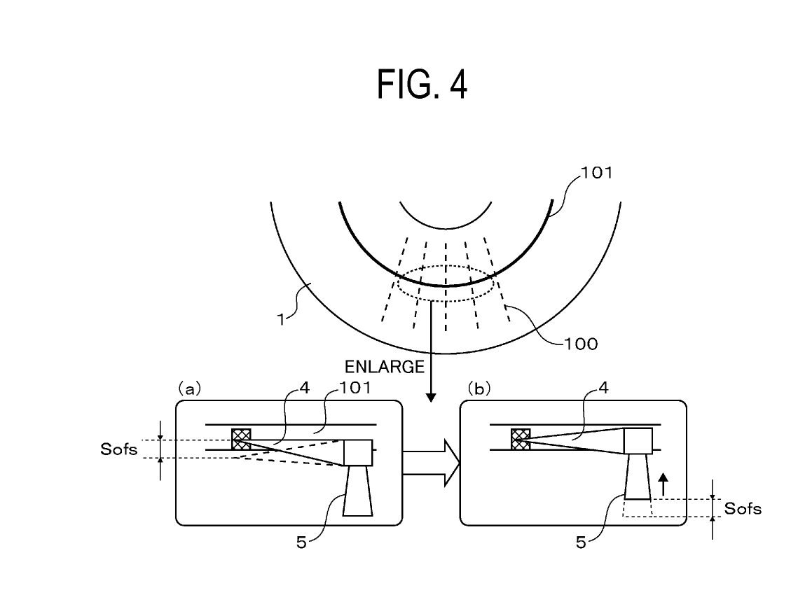

FIG. 4 is a diagram for explaining the operation of dual servo control, according to this embodiment.

The servo control of the magnetic head 4 is achieved using a dual servo technique which is a combination of control by the fine-motion stage 7 (or the head cartridge 5) and control by the fine-motion actuator which is built in the magnetic head 4. As shown in FIG. 4 (a), in the normal control, tracking is done along a servo track 101 by the fine-motion actuator of the magnetic head 4. In the measurement of the read/write characteristics of the magnetic head 4, if the amount of deviation between the magnetic head 4 and the servo track 101 increases due to a drift factor, such as heat generated from the magnetic head 4 or thermal expansion of the magnetic disk 1, the value of movement (offset) Sofs of the fine-motion actuator increases as well. If the offset Sofs reaches the saturation region of the fine-motion actuator, stable servo control is not possible. In this embodiment, the offset Sofs of the fine-motion actuator is monitored using a voltage applied to the magnetic head 4, and the applied voltage (movement) is controlled not to exceed an acceptable range.

When the applied voltage of the magnetic head 4 exceeds the acceptable range, as shown in FIG. 4 (b), the fine-motion stage 7 (or the head cartridge 5) is driven, and the magnetic head 4 is moved in a direction of the arrow by the offset Sofs. As a result, the offset Sofs remaining in the fine-motion actuator is canceled, and the offset Sofs of the fine-motion actuator can be kept in the acceptable range. Returning back to FIG. 4 (a), the servo control by the fine-motion actuator is restarted. Accordingly, while the voltage applied to the magnetic head 4 (fine-motion actuator) is monitored, if the applied voltage exceeds the acceptable range, the magnetic head 4 is moved by the fine-motion stage 7 (or the head cartridge 5). As a result, the movement of the magnetic head 4 is prevented from reaching the saturation region due to a drift factor, thus realizing stable servo control.

According to this embodiment, dual control is performed, that is, the tracking on the servo track is performed using the DSA function of the magnetic head, and then the fine-motion stage (or the head cartridge) is used for controlling drift components. As a result, the servo tracking during the magnetic head inspection is stably performed, thus enhancing the reliability of the inspection data.

What is claimed is:

1. A magnetic head inspection apparatus which inspects a characteristic of a magnetic head having a built-in fine-motion actuator, comprising:
a fine-motion stage which performs positioning of the magnetic head in a predetermined position on a magnetic disk;
a data process circuit which measures a movement characteristic of the fine-motion actuator; and
a servo control circuit which controls the magnetic head to track a servo track on the magnetic disk, based on a measurement result of the data process circuit, and wherein
when a value of movement of the fine-motion actuator exceeds an acceptable range in accordance with the measurement result, the servo control circuit drives the fine-motion stage and controls the magnetic head to move in a manner that the value of movement of the fine-motion actuator remains within the acceptable range.

2. The magnetic head inspection apparatus according to claim 1, wherein:
the data process circuit applies a constant amplitude sine wave voltage to the fine-motion actuator, and reads a servo pattern on the magnetic disk, thereby measuring the movement characteristic of the fine-motion actuator; and
a frequency of the sine wave voltage to be applied is set that a maximum point and a minimum point of a sine wave are synchronized with positions of the servo pattern on the magnetic disk.

3. A magnetic head inspection method for inspecting a characteristic of a magnetic head having a built-in fine-motion actuator, the method comprising the steps of:
measuring a movement characteristic of the fine-motion actuator built in the magnetic head, to obtain an acceptable range of a value of movement;
moving the fine-motion actuator, to control the magnetic head to track a servo track on the magnetic head; and
when the value of movement of the fine-motion actuator exceeds the acceptable range, controlling a fine-motion stage having the magnetic head mounted thereon to move, to control the value of movement of the fine-motion actuator to remain within the acceptable range.

4. The magnetic head inspection method according to claim 3, wherein:
the step of measuring the movement characteristic of the fine-motion actuator includes measuring the value of movement, by applying a constant amplitude sine wave voltage to the fine-motion actuator and reading the servo pattern on the magnetic disk; and
the frequency of the sine wave voltage to be applied is set that a maximum point and a minimum point of a sine wave are synchronized with positions of the servo pattern on the magnetic disk.
